(19) United States
(12) Patent Application Publication
(10) Pub. No.: US 2016/0169388 A1
(43) Pub. Date: Jun. 16, 2016

(54) SEAL FOR USE WITH OBLIQUE JOINTS

(71) Applicant: Caterpillar Inc., Peoria, IL (US)

(72) Inventors: ERIC HALLA, Peoria, IL (US); KHALED M. MOHAMMAD, Tremont, IL (US)

(73) Assignee: Caterpillar Inc., Peoria, IL (US)

(21) Appl. No.: 14/571,947

(22) Filed: Dec. 16, 2014

(51) Int. Cl. F16J 15/06; F16J 15/10

(52) U.S. Cl. CPC F16J 15/062; F16J 15/104

(57) ABSTRACT

Provided is a first seal member that comprises a body that defines an aperture having a perimeter that extends along an axis in a first direction from the body. The first seal member also includes a first sealing feature that is immediately adjacent at least a portion of the perimeter of the aperture that extends along a path in a second direction that is oblique to the first direction along which the aperture extends. In certain embodiments, a second seal member may also be provided that comprises a body that includes a perimeter wherein said perimeter of said aperture of the first seal member is complimentary shaped for receiving the perimeter of the second seal member.

### TECHNICAL FIELD

The present disclosure relates to a seal that provides a fluid tight joint that forms an oblique angle with another fluid tight joint.

### BACKGROUND

The difficulty of forming fluid tight joints that form oblique angles such as perpendicular angles with each other is well known in the art. Such situations have been handled in various ways. For example, it is known in the art to use a seal for one joint that sits on top of another seal that seals the other joint. Liquid sealant is added near the interface of the two seals to provide a fluid tight joint at this junction. For example, one seal will have a bead of liquid sealant placed onto it and another seal is then placed on top of the bead of liquid sealant which hardens quickly. This with added compression is intended to remove any voids between the seals that could lead to a leak. However, this solution often results in leaks because of the difficulty of getting a perfect interface between the seals and the liquid sealant.

Another example of a prior solution to this problem is disclosed by U.S. Pat. No. 8,342,538 to Fonville et al. The title of this patent is “Gasket-End Feature for Sealing a T-Joint Assembly”. As the title suggests, the T-Joint is a description of a compound joint that includes two perpendicular joints formed by three structural or frame members. The gasket includes a triangular shaped end portion that sits in a pocket proximate the intersection of these two perpendicular joints and that is compressed in three directions when the three structural or frame members are attached or fastened to each other (see FIG. 3 of Fonville). While this solution may work in some instances, it requires that the pocket be machined with a high degree of accuracy and that the dimensions of the triangular shaped end portion of the gasket be manufactured with relatively tight dimensional variances as a proper compression of the triangular shaped end portion in all three directions must be accomplished simultaneously to provide a fluid tight joint.

Accordingly, it is desirable to find a solution that is more reliable and easily manufactured than is now known.

### SUMMARY

A first seal member is provided that comprises a body that defines an aperture having a perimeter that extends along an axis in a first direction from the body. The first seal member also comprises a first sealing feature that is immediately adjacent at least a portion of the perimeter of the aperture that extends along a plane that is oblique to the first direction along which the aperture extends.

A seal assembly is provided that comprises a first seal member that comprises a body that defines an aperture including a perimeter that extends along an axis in a first direction from the body. The first seal member also comprises a first sealing feature that is immediately adjacent at least a portion of the perimeter of the aperture and that extends along a path in a second direction that is oblique to the first direction along which the aperture extends. The seal assembly further comprises a second seal member that comprises a body that includes a perimeter wherein said perimeter of said aperture of the first seal member is at least partially complimentary shaped for receiving the perimeter of the second seal member. The second seal member also comprises a sealing portion around its perimeter that extends in a direction that is oblique to its perimeter.

An apparatus is described herein for providing sealed oblique joints. The apparatus comprises a first frame member; a second frame member that forms a first joint with the first frame member; a third frame member that forms a second joint with the first or second frame members wherein said joints extend in oblique directions with respect to each other; a first seal member that is in contact with the first, second and third frame members and that comprises an opening that includes a perimeter; and a second seal member that is in contact with the first and second frame members for sealing said first joint and is in contact with at least a portion of the perimeter of the opening of the first seal member.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 shows an environment such as an engine where oblique sealed joints are present according to one possible application of an embodiment of this disclosure.

FIG. 2 is an enlarged side view of the engine of FIG. 1 showing the joints more clearly and associated seals and seal retaining structure in hidden lines.

FIG. 3 shows a perspective view of an apparatus similar to FIGS. 1 and 2 with one of the frame members removed to more clearly show the seals and structure for holding the seals.

FIG. 4 shows the apparatus of FIG. 3 with both the top frame members removed to more clearly show the first seal member as it is held in the bottom frame member and the second seal member as it is held within the aperture of the first seal member.

FIG. 5 is an enlarged view of the apparatus of FIG. 4 with the second seal member and top frame members removed to more clearly show the sealing feature and aperture of the bulbous portion of the first seal member.

FIG. 6 is a further enlarged view of the apparatus of FIG. 5 showing the dam that connects various sealing features of the first seal member.

FIG. 7 is a top view of the first seal member in isolation from the apparatus of FIGS. 2 thru 6.

FIG. 8 is a front view of the first seal member of FIG. 7.

FIG. 9 is a cross-sectional view of the first seal member taken along lines 9-9 of FIG. 7 through its bulbous portion.

FIG. 10 is a simplified view of an end portion of the first seal member showing its dimensions in the compressed and free states.

FIG. 11 is a perspective view of an alternate embodiment of a first seal member.

FIG. 12 is a top view of the alternate embodiment of the first seal member of FIG. 11.

FIG. 13 is a front view of the alternate embodiment of the first seal member of FIG. 11.

FIG. 14 is a cross-sectional view of the alternate embodiment of the first seal member of FIG. 12 taken along lines 14-14 thereof.

FIG. 15 is an exploded assembly view of the apparatus shown in FIGS. 2 thru 6 showing the second seal member being inserted into a slot positioned in one of the top frame members and the top frame members being fastened to one another, creating a first subassembly.

FIG. 16 is an exploded assembly view of the apparatus shown in FIGS. 2 thru 6 showing the first seal member being inserted into a slot positioned in the bottom frame member, creating a second subassembly.

FIG. 17 shows the assembly of the subassemblies shown in FIGS. 15 and 16 where the top frame members are fastened to the bottom frame member as the first seal member receives the free end of the second seal member while at the same time the first seal member and the junction between the first and second seal members are compressed to provide a fluid tight seal.

FIG. 18 shows an alternate method of assembling an embodiment of the present disclosure where the first seal is inserted into a slot positioned on the bottom of the top frame members such that the free end of the second seal member is first placed into the aperture of the first seal member and then the remainder of the first seal member is inserted into the slot before the bottom frame member is fastened to the top frame members.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b etc. It is to be understood that the use of letters immediately after a reference number indicates that these features are similarly shaped and have similar function as is often the case when geometry is mirrored about a plane of symmetry. For ease of explanation in this specification, letters will often not be included herein but may be shown in the drawings to indicate duplications of features discussed within this written specification.

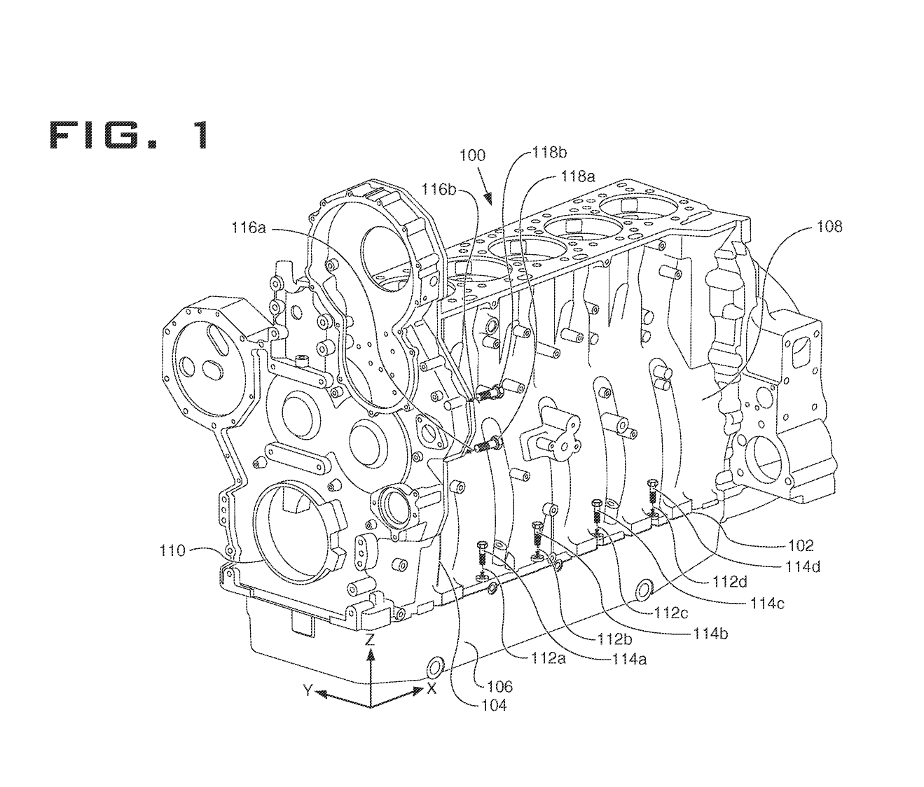

FIG. 1 depicts an engine 100 that has oblique sealed joints 102, 104 that extend in the horizontal and vertical directions respectively in an application where an oil pan 106 is attached to an engine block 108 and housing 110. In such a case, the seals (not shown) need to keep the oil contained in the engine system or the system will leak oil that might lead to the engine being shut down or damaged. This is only one embodiment of the present disclosure and further embodiments are contemplated where any type of fluid may be contained by oblique sealed joints in a host of applications. For this embodiment, the oil pan 106 is attached or fastened (step 112 in FIG. 1) to the engine block 108 using fasteners 114 and the housing 110 is attached or fastened (step 116) to the engine block 108 using fasteners 118.

A coordinate system for establishing X, Y, Z Cartesian coordinates is provided. For the embodiment illustrated in FIG. 1, the X-Y plane corresponds to a horizontal plane and the X-Z and Y-Z planes correspond to vertical planes. However, it is to be understood that the joints may not be coincident with any Cartesian plane and therefore embodiments where these joints are skewed relative to the horizontal and vertical planes are included in the present disclosure.

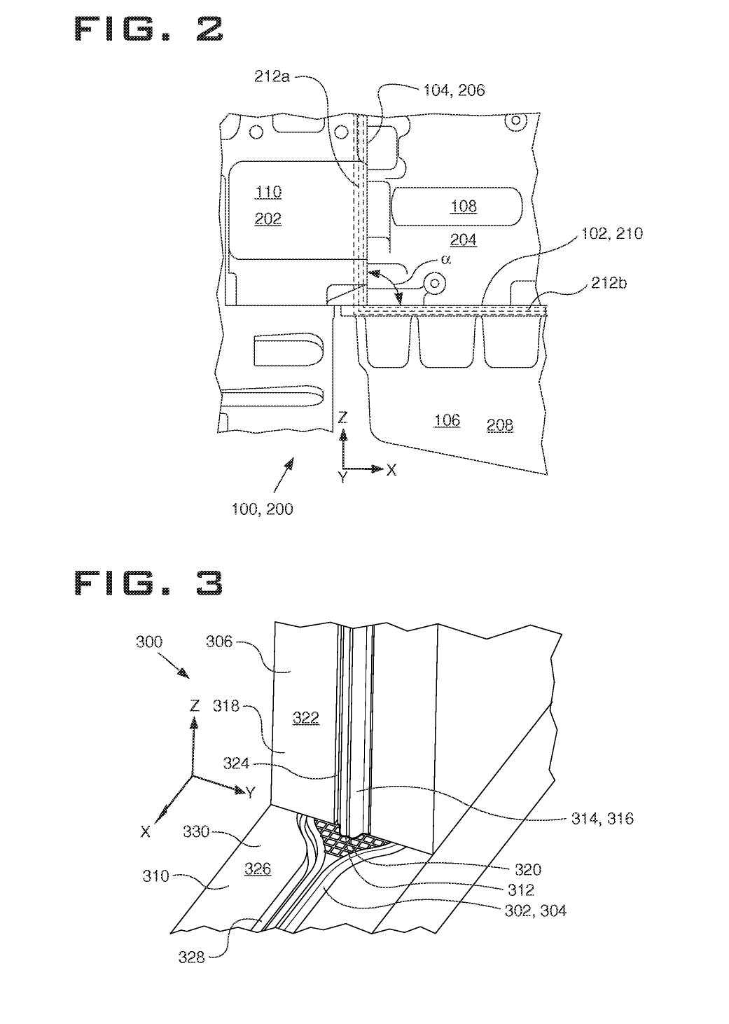

FIG. 2 is an enlarged side view of the engine 100 of FIG. 1. Of course, this embodiment may be applied to any apparatus 200 that includes a first frame member 202, which in this embodiment is the housing 110 of the engine, a second frame member 204, which in this embodiment is the engine block 108, which together forms a first joint 206 with the first frame member 202. A third frame member 208, which in this embodiment is the oil pan 106, is also provided that forms a second joint 210 with the first and second frame members 202, 204. As shown, the first joint and second joints 206, 210 are planar and extend from each other at an angle α. Obviously, this angle α does not have a value of 0 or 180 degrees, indicating that said joints extend in oblique or non-parallel directions with respect to each other. Similarly, seals and structure found in the frame members that retains the seals are shown in hidden lines 212. It follows that these seals and retaining structures also form angles that are oblique to each other as will be described further later in this disclosure. In particular, angle α is 90 degrees for this embodiment of the present disclosure indicating that the joints, seals and various seal retaining structures associated therewith are also perpendicular or orthogonal to each other.

It is contemplated that in certain embodiments of the present disclosure that the joints may be something other than planar such as having contoured or complex surfaces depending on the application. In such cases, the angle between the joints, seals and various seal retaining structures would be measured using tangents to the various features taken at the area or point where they intersect.

The frame members can be moving members or stationary members depending on the application. For example, the first frame member 202 could be part of a housing 110 that may or may not be split, the second frame member 204 could be part of an engine block 108, and the third frame member 208 could be part of an oil pan 106, all of which are stationary relative to a machine. These versions of the frame members correspond to the application for the embodiment depicted in FIG. 1. In other embodiments, these various frame members may define a cavity for a rotational molding or spin casting machine that is sealed using seal members as described herein. In such a case, the frame members would move while the seals prevent any material from leaking from the apparatus. In any embodiment, the housing may be split once or twice meaning that there may be as many as 2, 4, or more oblique joints. In such a case, multiple sealing arrangements for sealing the oblique joint would be provided. However, other applications where the various frame members comprise other components of an apparatus are contemplated and in some cases only one or two such oblique joints may be present. Frame members are typically made from metal, plastic, or any suitably rigid material that allows them to satisfy some structural or support function for the apparatus to which they are connected and to supply enough compressive force to a seal member to create a fluid tight seal of some sort.

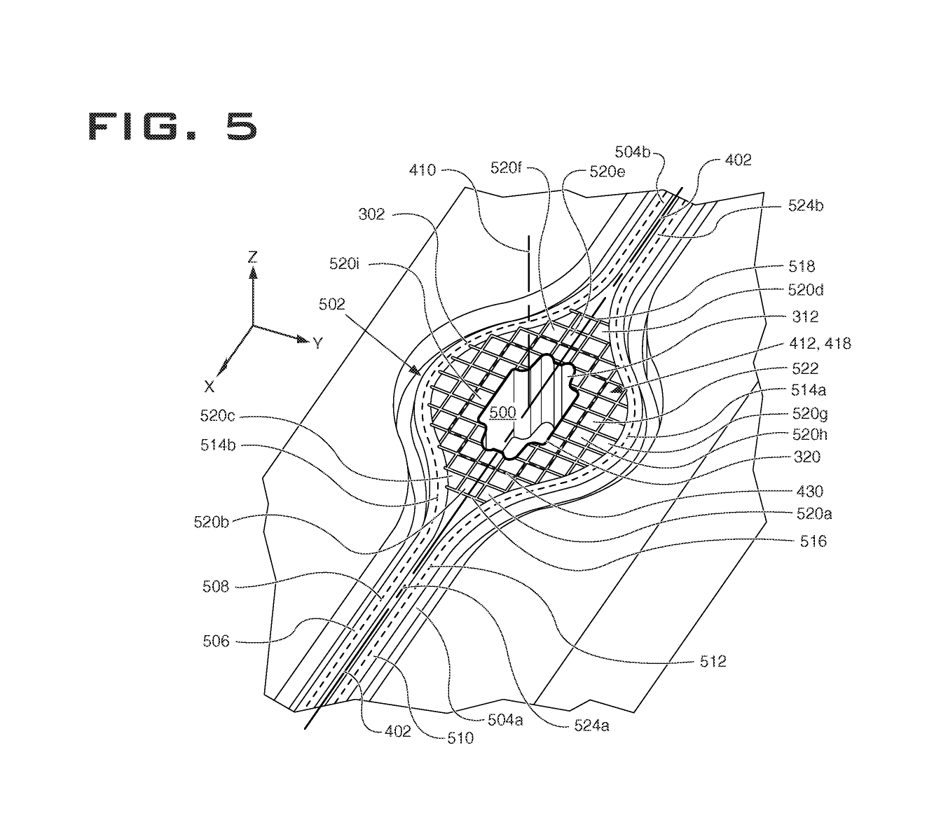

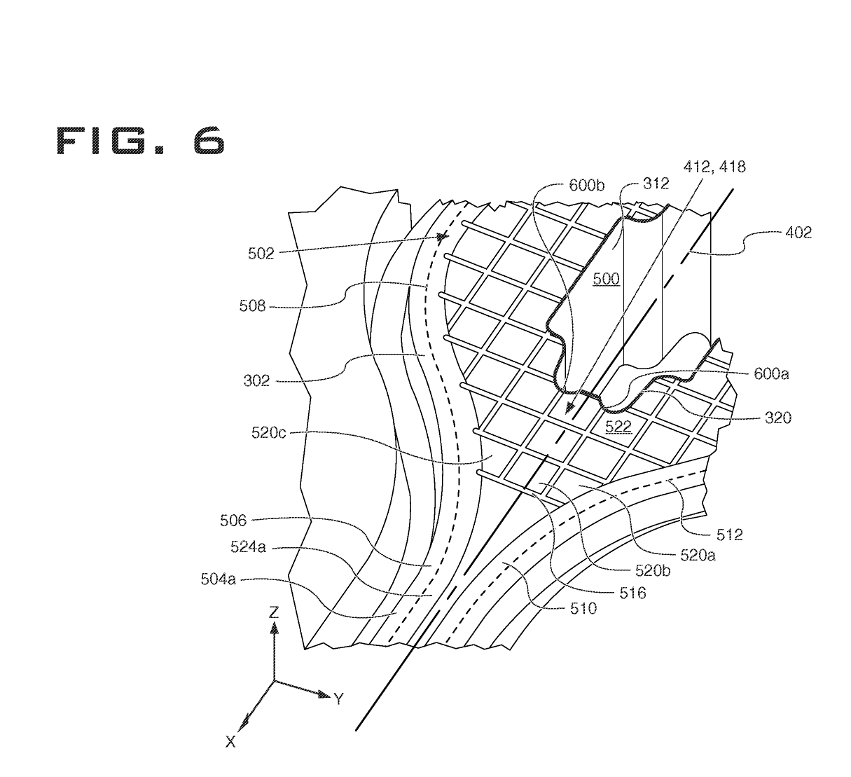

Turning now to FIG. 3, the seals and seal retaining structures of the first embodiment of the present disclosure can be more clearly seen. It is intended that the geometry for this embodiment be loosely related to those discussed for FIGS. 1 and 2, indicating that it can be used in virtually any desirable application including the engine application of FIGS. 1 and 2. The apparatus 300 includes a first seal member 302 with a body 304 that is in contact with the first frame member 306, second frame member (not shown in this figure) and third frame member 310. The first seal member 302 comprises an opening or aperture 312 defined by the body 304 (aperture is best seen in FIGS. 5 and 6). The apparatus further includes a second seal member 314 with a body 316 that is in contact with the first frame member 306 and second frame member (not shown) for sealing a first joint 318 and is in contact with the perimeter 320 of the opening 312 of the first seal member 302.

The first frame member 306 includes a surface 322 that faces the second frame member and that defines a slot 324 configured to hold the second seal member 314 while the third frame member 310 comprises a surface 326 that faces the first and second frame members and that defines a slot 328 configured to hold the first seal member 302. As a result, a second joint 330 is formed by the third frame member 310 and the first frame member 306 and the second frame member (not shown). However, it is contemplated that in other embodiments the second frame member may have a slot configured to hold the second seal member or both the first and second frame members may have slots for holding the second seal member. Likewise, in other embodiments it is contemplated that the first and second frame members may comprise surfaces that face the third frame member that defines slots that are configured to hold the first seal member. Or alternatively, all the surfaces of the first, second and third frame members that face each other may contain or define seal retaining geometry such as slots. It is contemplated that the second joint may be formed by only two frame members such as when four frame members are used creating a four way intersection, in which case, two sets of oblique joints are created by the four frame members and the seal members. In this scenario, two second seal members may extend into the aperture of the first seal member from opposite sides.

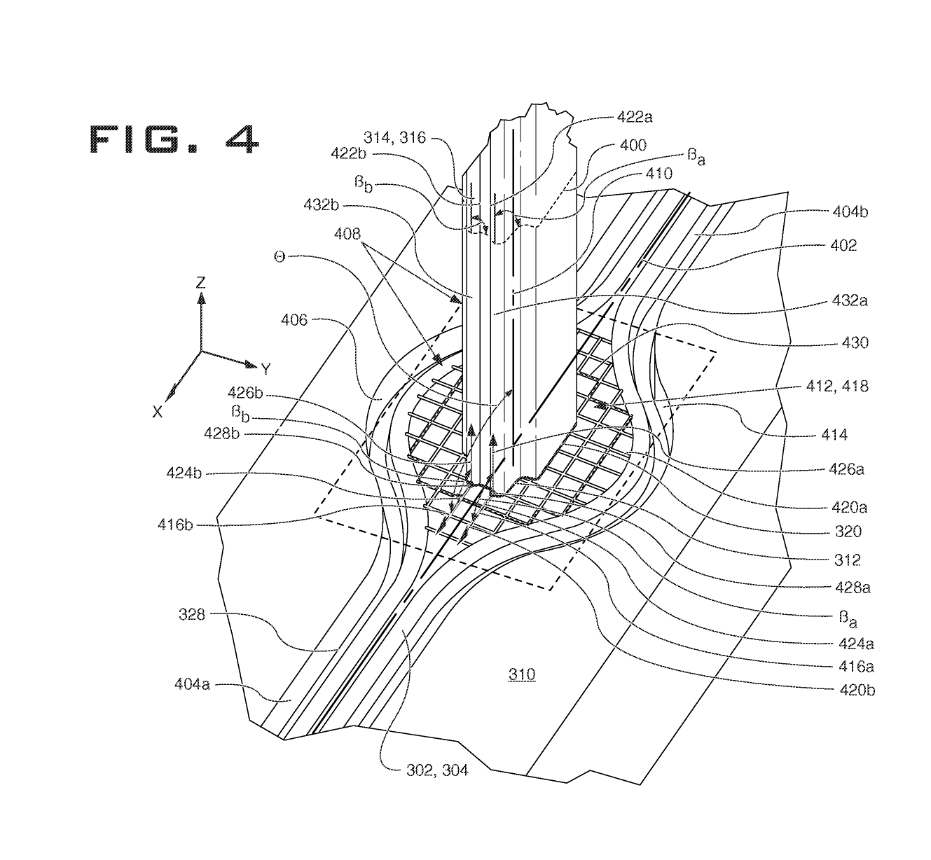

For this embodiment, the second seal member 314 extends into the aperture 312 as best seen in FIG. 4 where both top frame members have been removed. The amount that the second seal member 314 extends into the aperture 312 may be varied as desired or optimized. In some embodiments, the second seal member 314 may be operatively associated with the first seal member 302 for retaining or holding the first seal member. For example, the opening 312 of the first seal member 302 may be a hole 312 with an enclosed perimeter 320 that is configured to frictionally receive the second seal member 314. In such a case, the inside surfaces 500 (best seen in FIG. 5) of the hole 312 or the exterior of the second seal member 314 may have a texture or other surface treatment that creates the friction needed to hold the seal members together (liquid sealant could be used as an aid in assembly as will be described later). Alternatively, the second seal member 314 may have a perimeter 400 that is slightly larger than the enclosed perimeter 320 of the aperture 312 for creating an interference fit between the second seal member 314 and the aperture 312 of the first seal member 302. In some situations such as when the aperture is not fully enclosed, it is contemplated that the portion of the second seal member that interfaces with the first seal member may form some sort of undercut with the first seal member, interlocking the two seal members together.

Looking now at the geometry of the slot 324 in the first frame member 306 as seen in FIGS. 3 and 15, it includes a rectangular profile that is sized and configured to hold the second seal member 314 in a manner known in the art so that it is retained in the slot, easing assembly, and protrudes a predetermined distance from the surface of the first frame member that faces the opposing surface of the second frame member so that proper compression of the seal is obtained when the first and second frame members are fastened to each other. This will be discussed in further detail later herein.

Similarly as shown in FIG. 4, the slot 328 of the third frame member 310 extends along a sweep path 402 (which is also the sweep path for the first seal member 302) and the slot 328 is configured to have a cross-section found in successive planes that are perpendicular to its sweep path that are varying along the sweep path 402. Specifically, the end portions 404 of the slot 328 have the same rectangular configuration as the slot found in the first frame member while the intermediate portion 406 of the slot has a generally bulbous or enlarged shape. The slot mimics the shape of the first seal member as will be described more completely later herein. The sizing of the slot including its width and depth ensures that the first seal is held or retained in the slot for ease of assembly and so that the seal extends a suitable distance away from the surface of the third frame member so that it contacts the opposing surfaces of the first and second frame members with enough compression to form a fluid tight seal. This will also be discussed in further detail later herein.

It should be noted that the first, second, and third frame members are fastened to each other by methods and devices commonly known in the art. For the embodiment shown in FIGS. 1 thru 6, standard bolt holes, screw holes and fasteners such as bolts or cap screws may be used to provide a reliable method for attaching each of the frame members together while allowing disassembly fairly easily to repair broken or worn out seals. The use of fasteners is specifically illustrated in FIG. 1. However, it is contemplated that fastening can be achieved using other methods such as welding.

As can be imagined, seals may need to be replaced from time to time such as when an engine is overhauled. Consequently, seal assemblies may be sold or otherwise be provided for replacing worn out seals. Accordingly as shown in FIGS. 2 thru 4, an embodiment of the present disclosure includes a seal assembly 408 that comprises two different seal members 302, 314. Focusing now on FIG. 4, the assembly includes a first seal member 302 comprising a body 304 that defines an aperture 312 having a perimeter 320 and that extends along an axis 410 in a first direction from the body 304. This body 304 further comprises a first sealing feature 412 that is immediately adjacent at least a portion of the perimeter 320 of the aperture 312 and that extends along a path or a plane 414 in a second direction that is oblique to the first direction along which the aperture extends (see angle θ). For the embodiment shown, the first sealing feature 412 includes a rounded seal bead 416 that extends in the X direction and that is part of an array or waffle pattern 418 that includes a series of interconnected horizontal sealing portions 420 with the identical cross-section that extend at right angles to each other in the X and Y directions. This cross-section comprises a half-circular shape that protrudes from the body.

Since four rounded curves are provided along the perimeter 320 (two of which are visible in FIG. 4 knowing that there are two more on the opposite side of the aperture obscured by the second seal member) of the aperture 312 of the first seal member 302 for receiving rounded sealing beads 422 of the second seal member 314 that extend in the vertical Z direction, four instances of the rounded sealing beads 416 (only two of which are shown) are provided coincident these vertical seals to prevent leaks and provide redundancy if a leak should occur at one junction of the horizontal and vertical seals. It is contemplated that these sealing features on the first seal member that are coincident with the vertical seals at point 428 may extend in directions other than in the X direction as long as they are found in a plane that is oblique to the axis along which the aperture extends.

Specifically for the embodiment shown, lines 424 and 426 indicate areas where a fluid tight seal is desired to provide oblique joints that are fluidly sealed, it being understood that these seals extend as far as necessary as indicated by the arrows along an uninterrupted perimeter to provide a fluid tight joint. For this embodiment, four such pairs of seals are provided (two on each side of the aperture) meaning that four such sealing portions 420 of the first seal member 302 define a plane 414 that is oblique to the axis 410 along which the aperture 312 extends. It is contemplated that in other embodiments the first seal portions of the first seal member may not be coincident with the seal features of the second seal member such as when there is a gap or distance between them in any direction. In such an embodiment or with any embodiment discussed herein, liquid sealant may be added to the joint during assembly to help prevent leaks.

In situations where the joints or seal members are not planar, the angle formed between the direction in which a sealing feature extends and the axis of an aperture will be taken along tangents of the various features located at places where these various features intersect or most closely intersect.

One skilled in the art would appreciate that when viewed as a whole, the array or waffle pattern 418 may be considered the first sealing feature 412 and that the various X and Y sealing portions 420 that make up the array could be considered to establish a perimeter 430 that completely surrounds the aperture 312. On the other hand, one skilled in the art would also appreciate that only one or two of these features of the array absent the rest of the array may be present so long as they extend to other sealing features that extend completely around the cavity that is to be sealed.

It is further contemplated that first sealing feature could comprise instead of a waffle pattern of sealing beads, a flat planar surface that completely surrounds the aperture in an uninterrupted manner. But it is contemplated that in other embodiments, this planar surface may only extend along a portion of the perimeter of the aperture of the first seal member. In some cases, this planar sealing surface may include a waffle pattern or array where concentric rings are formed immediately around the aperture and around the outer perimeter of the pad with an array of seal connecting portions found between the rings, separated by small cavities or reservoirs.

As best seen in FIG. 4, the seal assembly 408 further comprises a second seal member 314 comprising a body 316 that includes a perimeter 400. The perimeter 320 of the aperture 312 of the first seal member 302 is completely complimentary shaped for receiving the perimeter 400 of the second seal member 314 and the second seal member further comprises a sealing portion 432 on its perimeter that extends in a direction that is oblique to its perimeter 400. In other embodiments, the perimeter of the aperture may only be partially complimentary shaped to the perimeter or profile of the second seal member as may be the case when clearance is provided in the corners of the aperture, helping to facilitate proper matching between sealing surfaces of the first and second seal members. In this embodiment as in many embodiments, the perimeter 400 of the second seal member 314 is parallel or in plane with the path of the first sealing feature 412 of the first seal member 302 and the seal 424 formed by the first sealing feature 412 of the first seal member 302 forms an angle β with the seal 426 formed by the sealing portion 432 of the second seal member 314 that is 90 degrees but may be some other value in other embodiments. That is to say for this embodiment, the first direction or plane that the sealing feature of the first seal member extends is perpendicular or orthogonal to both the directions that the axis of the aperture extends and that the sealing portion of the second seal extends but the values of angles θ and β may be something other than 90 degrees and may be different than each other in certain embodiments.

“Sealing feature” or “sealing portion” as used herein means any feature of a seal that is intended to contact a frame member to prevent fluid from passing by the seal. It may have any suitable configuration already known or that will be devised in the art including flat, pointed, rounded, curved or undulating, etc. In cases where the seals are not coincident in either the uncompressed or compressed state or there is otherwise a gap or distance between them or between a sealing feature and a frame member, contact between the frame member and the sealing feature may be facilitated using a liquid sealant that is located between the sealing feature and the frame member. Also, the liquid sealant may eliminate any voids found between the seal members. A “seal member” as used herein is a member that comprises a “sealing feature” or a “sealing portion”.

As illustrated by FIGS. 3 and 4, the second seal member 314 extends into the aperture 312 of the first seal member 302. The perimeter 400 of the second seal member 314 may be at least partially larger than the perimeter 320 of the aperture 312 of the first seal member 302 providing an interference fit or a press-fit. Or conversely, there may be a slip-fit or a slight gap between the inner surfaces 500 of the aperture and the perimeter 400 or exterior surfaces of the second seal member 314. Finally, the design may be line-to-line where neither a slip-fit nor a press-fit exists. These different conditions may be used with different embodiments to make joints that are fluid tight as a result of design optimization.

In order for seals to work as intended for many applications, a certain design criteria is desirably met such that a minimum of 90% to 95% (95% being the nominal of the desired range), of the void in which the seal sits is filled after the seal has been compressed. If not enough void is filled, there may be insufficient force to create enough compression to keep the seals effective against high fluid pressure acting on the seals, resulting in a leak. On the other hand, if too much void is filled, the seal will not allow the joints to close properly or the seals may be compressed too much leading to seal damage, which may also lead to a leak.

Accordingly, tolerances and designs of the areas surrounding the junction of the oblique seals as well as seal dimensions of the seals themselves may dictate whether a press-fit, slip-fit or line-to-line design is needed to create an optimized sealing of the joints. In cases where the area where the interface or junction between the seals has more volume such as if there is clearance between the perimeter of the bulbous portion and the slot immediately around this part of the seal, a press fit between the seals may be warranted. If there is compression between the groove and this enlarged portion of the seal, then a slight gap may be warranted. Likewise, the extent to which the second seal protrudes into the aperture may be adjusted to obtain the desired seal. It is contemplated that the second seal member may extend anywhere from half way through the depth of the aperture to 95% of the depth of the aperture for many embodiments. In any event, the second seal member will usually extend past the first sealing features of the first seal member in order to create the orthogonal seals as discussed above.

As described previously, the perimeter 320 of the aperture 312 of the first seal member 302 as depicted in the drawings is completely enclosed. However, it is contemplated that this might not be the case in other embodiments. Typically, the perimeter 320 of the aperture 312 will extend past the sealing portion of the second seal member to create the desired oblique or orthogonal seals. For example, if half of the first seal member was eliminated by sectioning the first seal member 302 through a X-Z plane taken through the sweep axis 402 of the first seal member as shown in FIG. 4, it is contemplated that this embodiment would still function and is therefore included in this disclosure.

The first and second seal members may be made of unitary construction. In such a case, the first seal member may be machined, molded or casted and the second seal member may be machined or extruded. However, it is contemplated that these seal members may be made from multiple components that are joined using methods that do not compromise the function of the seals or may be manufactured using any desirable method.

In addition, the first and second seal members may be made from the same material or different materials depending on the application. Any suitable material currently used for seals or that will be devised in the art may be employed to make either seal member. For example, seal members are commonly produced from sheet, extruded, or molded materials such as paper, rubber, silicone, polyurethane, plastic polymer, elastomer, etc. Selection of the appropriate material may depend on a number of factors including the temperature and pressures of the environment in which the seal member is intended to be used and its chemical compatibility with the fluid it is meant to contain. For the embodiments shown in the drawings herein, it is contemplated that the seal members would be made from the same elastomer that is already known in the art.

Focusing on FIG. 4, it can be seen that the first and second seal members 302, 314 both have at least two planes of symmetry and preferably three planes of symmetry. Specifically, the first seal member 302 is symmetrical about a X-Z plane taken through its sweep path 402, a Y-Z plane taken through the axis 410 of its aperture 312 and a X-Y plane taken at a level that is half-way through its thickness in the Z direction. Similarly, the second seal member 314 is symmetrical about the X-Z plane taken through the sweep path 410 (as its sweep path is coincident with the axis of the aperture 312) of the second seal member 314, the Y-Z plane taken through the sweep path 410 of the second seal member 314, and a X-Y plane taken at a height that is half its total length in the Z direction. Such symmetry helps to fool proof the assembly of the seals as an assembler can flip either seal around in two or three different directions and install the seal without any concern that the seal will not work properly. It is contemplated that either seal member in other embodiments would have fewer planes of symmetry, such as one or two planes of symmetry, or would not have any planes of symmetry.

The terms “symmetry” or “mirrored” as used herein means that a first set of geometry is substantially similar to another set of geometry so that one set of geometry is functionally equivalent to other set of geometry. As such, minor geometrical and structural differences related to manufacturing variances such as sink marks and voids, molding vestiges such as gates, ejector pin marks and undercuts, draft, etc. are not considered to affect the symmetry or mirroring of geometry in a functional sense.

Looking now at FIGS. 5 and 6, the central, enlarged or bulbous portion 502 of the first seal member 302 can be seen. This portion comprises the first sealing feature 412 in the form of a pad that includes a waffle pattern or array 418 that has a perimeter 430 that completely surrounds the perimeter 320 of the aperture 312 and that extends in an X-Y plane as shown. First and second end portions 504 (which are narrower portions compared to the bulbous portion of the seal) connect to this bulbous portion 502 and include a second sealing feature 506 that extends along a first sweep path 508 that is oblique to the first direction along which the axis 410 of the aperture 312 extends and a third sealing feature 510 that extends along a second sweep path 512 that is oblique to the first direction along which the aperture extends. The sweep paths include curved portions 514 that curve away or outwardly from the aperture 312 and that reconvene on the other side of the aperture, helping to create or provide the perimeter of the bulbous portion 502 of the first seal member 302.

For this embodiment, the second and third sealing features 506, 510 of the first seal member 302 are essentially parallel and are symmetrical about the X-Z plane taken through the sweep axis 402 of the first seal member. The first and second sweep paths 506, 510 are also perpendicular to the first direction along which the aperture extends but these angles may be varied as desired. However, it is possible that in other embodiments that no end portions would exist and only the bulbous portion would be present for use in applications such as discussed in U.S. Pat. No. 8,342,538 to Fonville et al. In other cases, only one end portion may exist. Furthermore, the angle at which these end portions 504 connect to the bulbous portion 502 is shown to be straight but they could be angled relative to each other in any Cartesian plane as desired.

The first seal member 302 further comprises a fourth sealing feature 516 and a fifth sealing feature 518 that connect the second and third sealing features 506, 510 and form at least one reservoir 520 between the first sealing feature 412 and the second or third sealing features 506, 510. For this embodiment, a multitude of reservoirs 520 are created between the many instances 420 of the first sealing feature 412 that extend from the aperture 312 to the second and third sealing features. The bottoms of the reservoirs 520 are defined by the web 522 that interconnects the instances of the first seal feature. These reservoirs and the multiple instances of sealing features that form them help to compartmentalize leaks along the horizontal joint and to provide more volume to allow the seal member to compress more easily without exceeding the 95% void volume fill guideline as described earlier herein. The fourth and fifth sealing features 516, 518 also provide barriers or dams that help to prevent fluid from entering the trough 524 found between the second and third sealing features 506, 510 as will be discussed further later herein. This helps to minimize the spread of leaks or to otherwise compartmentalize such leaks along the horizontal joint 330.

FIG. 6 shows clearly the points 600 of the rounded seal beads 416 of the first sealing feature 412 that are positioned to be tangent to the curved portions of the perimeter 320 of the aperture 312 where the rounded seal beads of the second seal member would be, creating the desirable oblique seals.

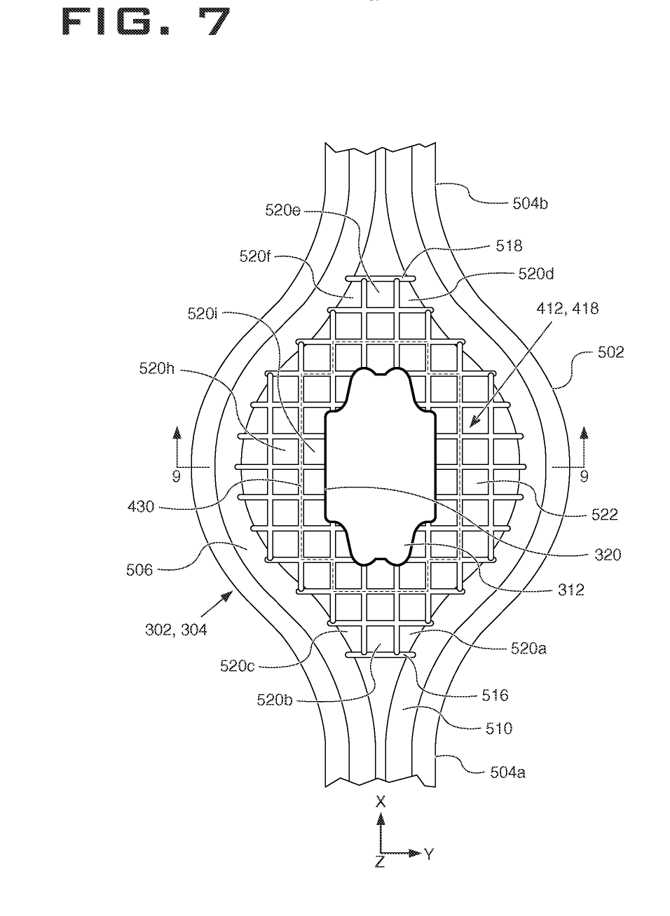

FIGS. 7 thru 9 show the first seal member 302 of FIGS. 3 thru 6 shown in isolation from any frame member. In some instances, it is only this seal member that may be damaged and need replacement. Also, the first seal member has more intricate geometry than the second seal member and may be more difficult to obtain as the second seal member may be obtained more readily from various manufacturers. Therefore, the first seal member may be sold or otherwise provided separately from the second seal member and a closer inspection of this component by itself is warranted.

FIG. 7 is a top view of the first seal member 302 showing features of the first seal member previously discussed including the aperture 312, array 418 of sealing portions that comprise the first sealing feature 412, reservoirs 520, and second, third, fourth and fifth sealing features 506, 510, 516, 518. Specifically, the first seal member 302 comprises a body 304 that defines an aperture 312 having a perimeter 320 that extends along an axis 410 (not shown in FIG. 7) in a first direction from the body 304, and a first sealing feature 412 that is immediately adjacent at least a portion of the perimeter 320 of the aperture 312 that extends along a path in a second direction that is oblique to the first direction along which the aperture extends. For this embodiment, the first sealing feature 412 extends completely around the perimeter 320 of the aperture along a perimeter 430 but this may not be true for other embodiments. Similarly, the aperture forms a completely enclosed perimeter but this may not be the case for other embodiments as previously described.

For this embodiment, the perimeter 320 of the aperture 312 is configured to receive a second seal member that comprises a perimeter wherein the perimeter of the aperture is at least partially, and for this embodiment, completely complimentarily shaped to the perimeter of the second seal member (see FIGS. 3 and 4 to see how the first and second seal members fit together). At least a portion of the perimeter of the second seal member comprises a sealing portion that extends in a direction that is oblique to the second direction along which the first sealing feature of the first seal member extends (see FIG. 4).

FIG. 8 is a front view of the first seal member 302 showing its profile for its end portions 504 that is similar or nearly identical to the profile or perimeter of the second seal member as shown in FIGS. 3 and 4. The first and second end portions as previously described are identical for this embodiment but may be configured differently for other embodiments and may not be end portions in yet other embodiments where additional features are added to them such as additional bulbous or enlarged portions for sealing other oblique joints. Only one end portion of the present embodiment will be discussed for brevity of time knowing that the other end portion is similarly constructed. Similarly, the profile of the aperture will not be discussed as it also substantially matches the profile of the end portion.

In FIG. 8, the body 304 of the first seal member 302 comprises a first portion or end portion 504 that includes a consistent cross-section found in successive planes perpendicular to the sweep path of the body of the first seal member taken along its sweep path. A second portion 502 may include a varying cross-section found in successive planes perpendicular to the sweep path of the body of the first seal member taken along its sweep path that defines the aperture of the first seal member. This first seal member may be used in conjunction with a second seal member 314 that comprises a second body 316 that also includes a consistent cross-section taken found in successive planes perpendicular to the sweep path of the body of the second seal member taken along said sweep path as seen in FIGS. 3 and 4. This consistent cross-section may have a similar shape as the consistent cross-section of the first portion 504 of the first body 304. In other embodiments, the perimeter 400 or profile of the second body 316 of the second seal member 314 may be different than any geometry of the first seal member except perhaps the perimeter of the aperture of the first seal member.

For this embodiment as shown in FIG. 8, the first body 304 of the first seal member 302 comprises a first side wall 800 including a surface normal 802, a second side wall 804 including a surface normal 806 that is diametrically opposite the first sidewall, a first projection 808 that extends from the body of the seal member and a second projection 810 that extends from the body of the seal member that is diametrically opposite the first projection. The first and second projections extend in directions perpendicular to the surface normals of the sidewalls. This consistent cross-section further comprises third and fourth projections 812, 814 that extend from the body of the seal member in directions perpendicular to the surface normals of the sidewalls. Each of the first, second, third and fourth projections terminate at their free ends with a rounded surface 816 that acts as a rounded sealing bead.

Furthermore, the first and second projection 808, 810 are spaced a predetermined distance from a sidewall 800, 804 measured along a direction that is parallel to the surface normal 802, 806 of the sidewall that is also parallel with the Y direction. For each projection 808, 810, a pair of blends 818 that has an inflection point 820 between them provides a transition between the sidewall and a side surface 801 of the projection. Similar geometry connects the third and fourth projections 812, 814 to the sidewall to which they are adjacent. The first and third projections 808, 812 are also adjacent each other along a direction parallel with a surface normal 802, 806 of a sidewall 800, 804 and are connected by a transitional feature 822 that forms a trough between the projections. Similar geometry exists between the second and fourth projections 812, 814.

The depth of the troughs 524 and amount the projections 808, 810, 812, 814 protrude up from the sidewalls 800, 804 as measured in the Z direction may be varied as desired to optimize seal performances such as seal rigidity and the ability to hold a desired amount of fluid in the troughs when one seal bead leaks. The pair of blends 818 that transition from the sidewall 800, 804 of seal member to the side surface of the adjacent projection provides a lead-in for easing assembly of the seal member into a slot as well as reducing stresses exerted on the seal body when it is compressed.

As the aperture 312 of the body 304 of the first seal member 302 is complimentary shaped to this cross-section, it is envisioned that the second body 316 of the second seal member 314 would also have a similarly shaped cross-section or perimeter 400 as previously described herein (see FIGS. 3 and 4). This may not be the case for other embodiments.

Returning to FIG. 7, it can be seen that the dams 516, 518 connect the first and second sealing features near the intersection of the end portions 504 with the bulbous portion 502 of the first seal member 302. As one can imagine, the bulbous section has a varying cross-section as one travels along the sweep path of the body of the first seal member until it reaches the center of the aperture where the bulbous portion is at its greatest width as will be described shortly. Accordingly, it can be intuitively appreciated that the dams are located near the intersection of the consistent and varying cross-sections of the body 304 of the first seal member 302.

It should be noted that if any seal member that has a transition from one type of geometry to another such as more narrow to wider uses a blend, chamfer or other gradual transition geometry, as is the case for this embodiment, there will exist a varying cross-section as one travels along the sweep path of the body. Furthermore, if there is a hole in the body that has transitional geometry such as blends, chamfers, etc., as is the case for this embodiment, there will be a varying cross-section as one travels along the sweep path of the body. Such transitional geometry is often desirable when making a component using a molding or casting process to avoid manufacturing anomalies such as sinks and voids as well as avoiding stress risers that could lead to cracking of the component when it is subjected to stress in use. Finally, the use of an array or waffle pattern for the first seal feature for the first seal member may also create a varying cross-section.

FIG. 9 illustrates the center cross-section of the bulbous portion 502 of the body 304 of the first seal member 302. It includes the aperture 312, the array 418 of rounded sealing beads 416 that are part of the first sealing feature 412, and the cross-section of the first, second, third and fourth projections 808, 810, 812, 814 and associated rounded sealing beads and a web 522 that connects these projections to the array. While the tangent of the rounded sealing surfaces of the members of the array may be at the same height as the tangent to the sealing beads as measured in the Z direction, it is contemplated that it may protrude higher or be recessed lower (as shown in FIG. 9) than the height of the sealing beads for reasons already discussed herein by a predetermined distance 900. The value of distance 900 for this embodiment is 0.05 mm but this can be varied as needed or desired. For example, in order to create the desired void volume fill after the seal has been compressed in use, it may be necessary to raise or lower the height of these features with respect to each other to obtain an optimized seal. In cases where the sealing surface(s) of the first sealing feature is/are recessed with respect to the height of the sealing beads when the seal member is in the uncompressed state, it is typically desirable that these sealing surface(s) at least contact(s) a frame member when the seal member is compressed to prevent fluid from leaking past the seal member. For this embodiment, the aperture 312 extends completely through the body but it is contemplated that the aperture could be a blind hole, that is to say, it would not extend all the way through the body in other embodiments.

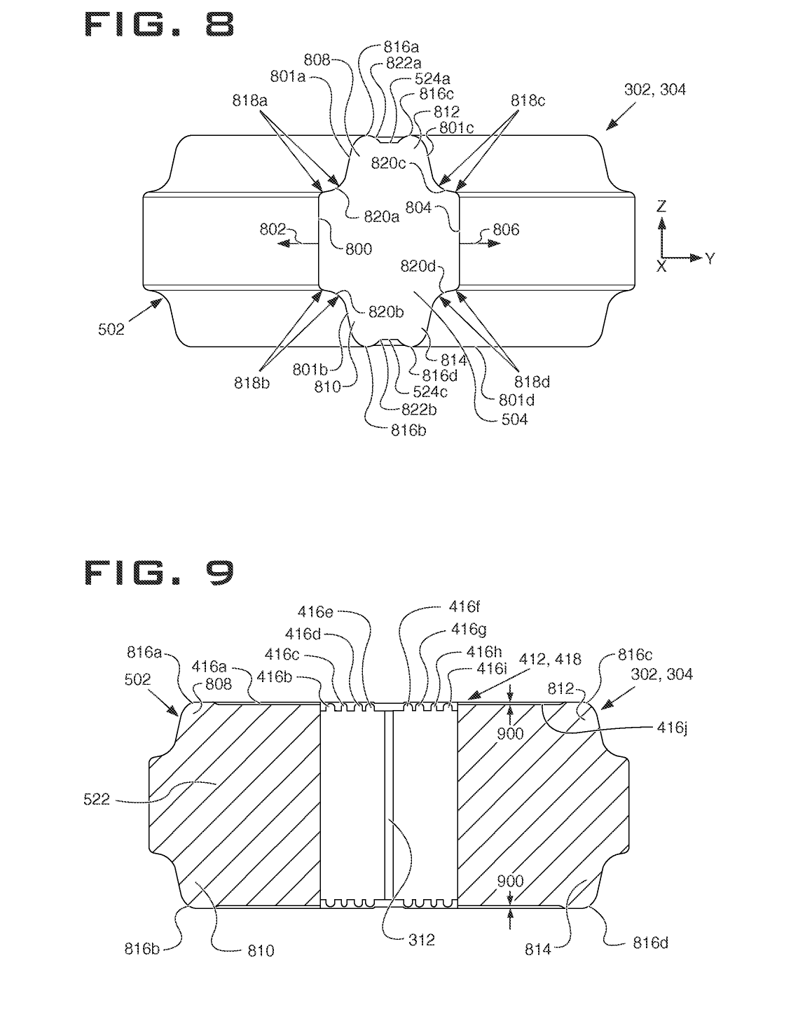

Compression of an end portion 504 of the first seal member 302 is depicted in FIG. 10. The outline of the body of the seal member in the free or uncompressed state is shown in dotted lines 1000 while the compressed state of the body of the seal member is shown in solid lines 1002. The initial width Wᵢ of the seal for this embodiment is 4.5 mm while the compressed width of the seal is the same as the width of the slot all as measured in the Y direction. For this embodiment, the width Wₛ of the slot is 4 mm meaning that there is a 0.25 mm compression on a side for the body of the seal member. Similarly, the height Hᵢ of the seal member from a sealing bead on one side of the body of the seal member to the opposite side as measured in the Z direction is 7.3 mm when uncompressed while the height Hₛ of the slot is 6 mm meaning that there is a 0.65 mm compression in the Z direction on a side of the body. The seal members discussed herein are “pressed-in” seals for easing of assembly so that they remain in place once inserted into slots or other seal retaining structure on the frame members. However, other embodiments of the present disclosure may include seal members that are not “pressed-in” seals.

Since the expansion of the seal body in the X-Y plane is related to the compression of the body in the Z direction per Poisson's ratio, it is contemplated that the desired amount of clearance between the perimeter of the aperture of the first seal member and the exterior perimeter of the second seal member for some embodiments can be roughly calculated by taken the total amount of compression of the seal member in the Z direction and multiplying it by the Poisson's ratio for the material from which the seal member is made. If the calculation is made accurately, then the clearance between the seal members would be effectively eliminated without over compressing either seal while maintaining contact between them, creating properly functioning obliquely sealed joints. Of course in many embodiments, some extra compression is desirable to help prevent fluid from seeping into the interface found between the first and second seal members. For the material of the embodiment now being discussed, the Poisson ratio is 0.5 meaning that the clearance between the aperture of the first seal member and the second seal member should be no more than half the designed compression of the seal in the Z direction assuming that the first seal member is limited or bound along its entire outside perimeter by a frame member.

Put another way, the volume of the seal and the volume of the void or gland can be calculated so that when the seal is fully compressed, a desirable void volume is filled, which should result in having sufficient contact being created at the junction of the two seal members.

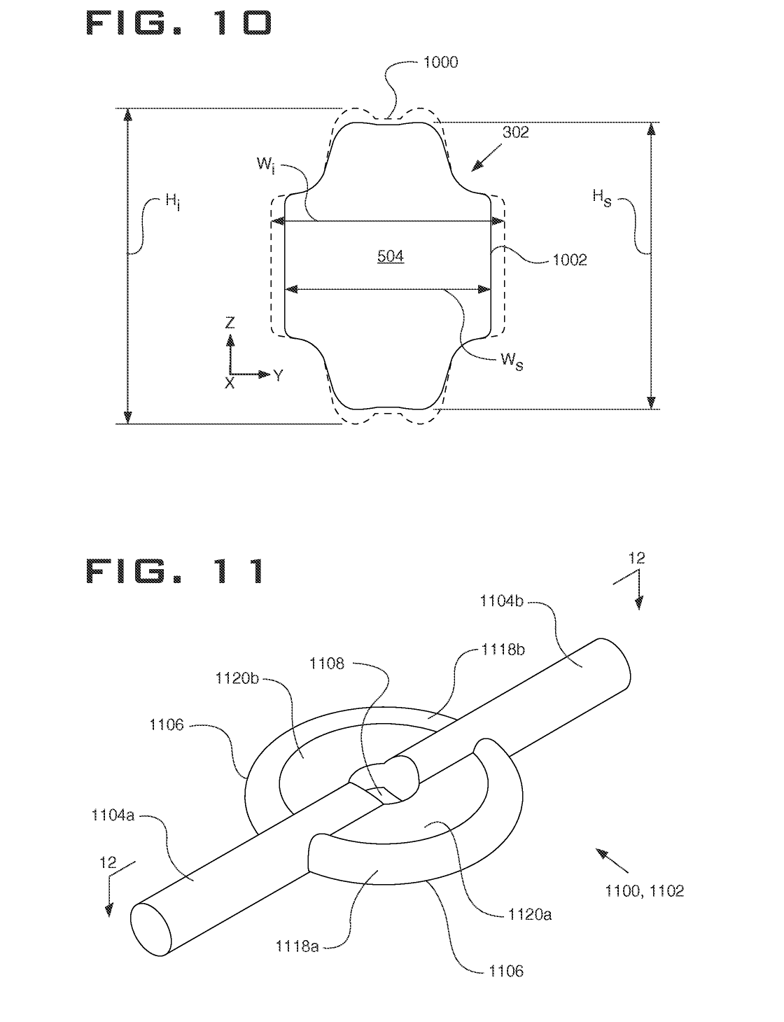

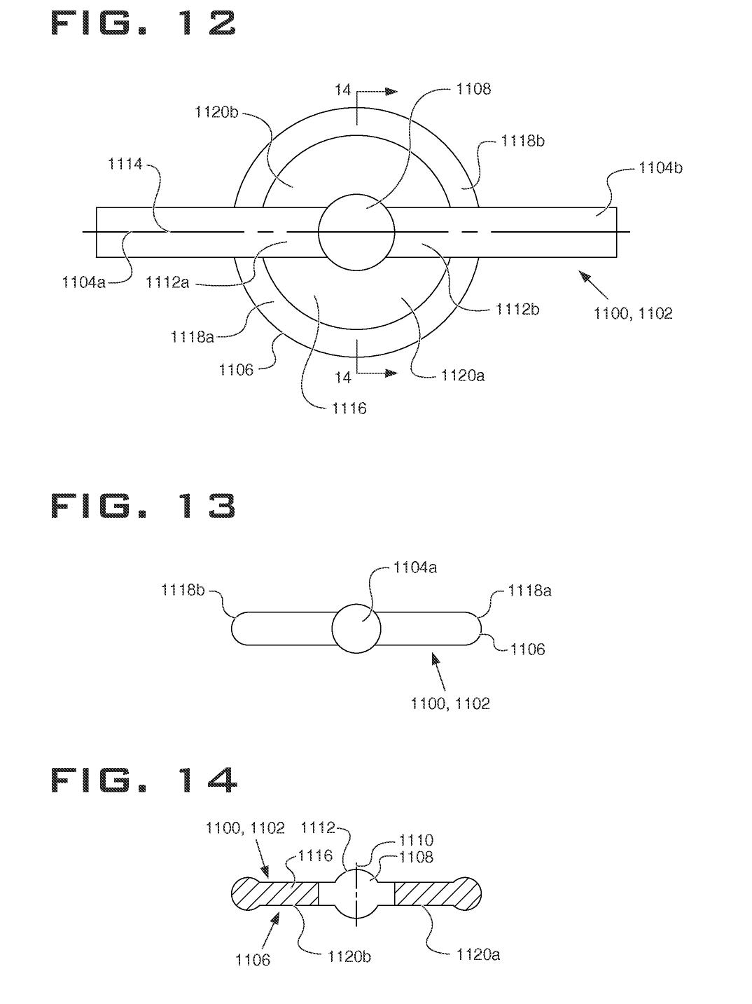

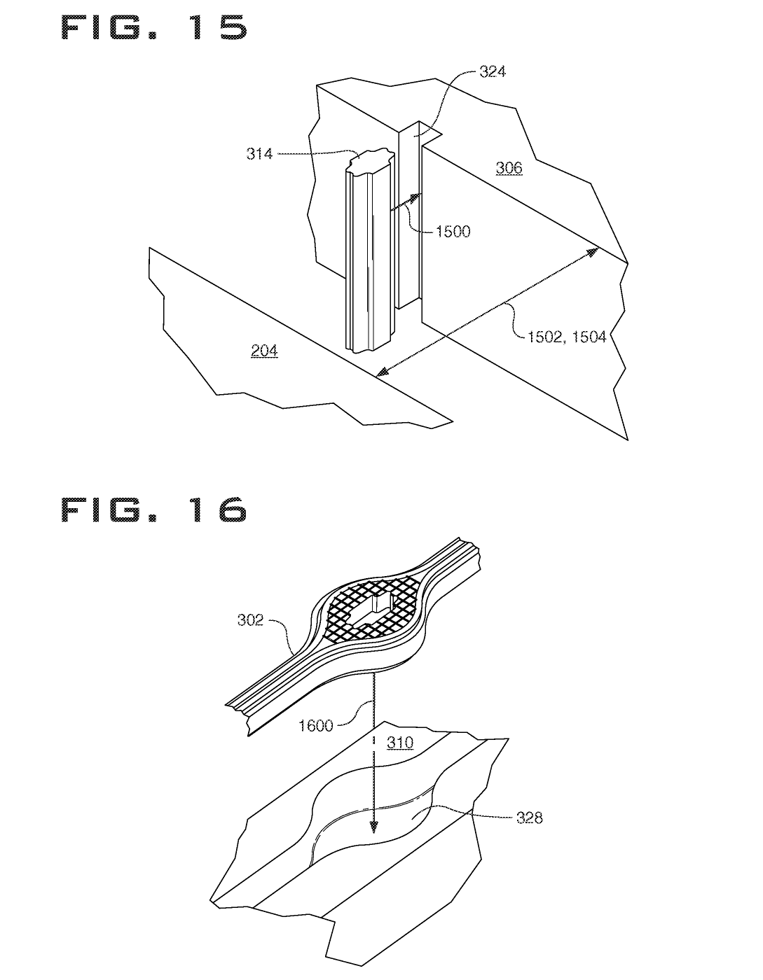

FIGS. 11 thru 14 illustrate an alternate embodiment of the first seal member 1100. It has a body 1102 with end portions 1104 that have a typical o-ring style profile that extend to an enlarged or bulbous portion 1106 where they separate and rejoin, providing a predominately circular perimeter as viewed from a top view. The body 1102 of the seal member defines a central opening 1108 positioned in the center of the bulbous portion 1106 and that extends completely through the body. The opening defines a first axis 1110 or direction that extends at a first direction from the body. Two sealing features 1112 are located on diametrically opposite sides of the opening that have a curved or rounded sealing profile (see FIGS. 13 and 14) and that extend in a second direction 1114 that is oblique to the first direction along which the aperture extends. The opening is configured to receive a second seal member (not shown) of known o-ring construction in a manner as already described earlier for other embodiments contained herein.

Focusing on FIG. 14, a web 1116 interconnects the various structural features of the enlarged portion 1106 of the body of this seal member including the first and second seal features 1112 and the peripheral or perimeter third and fourth seal features 1118 formed by the divergence and convergence of the end portions 1104 as they transition to the enlarged portion of the body of the seal member. The end portions extend with the first and second seal features 1112 around the perimeter of a cavity holding fluid or to other enlarged portions for sealing other oblique joints in like manner as previously described for other embodiments herein.

Unlike some other embodiments, this embodiment does not have a redundancy of sealing features along a perimeter of a cavity so no trough is created between adjacent seal features, which provides a buffer for capturing fluid before it creates a leak. However like preceding embodiments, two reservoirs 1120 are created on either side of the aperture. Other embodiments where no such reservoirs exist are also part of the present disclosure.

Any of the variations discussed with respect to earlier embodiments of the present disclosure apply in equal force to this embodiment shown in FIGS. 11 thru 14 as appropriate to create yet further embodiments of the present disclosure.

### INDUSTRIAL APPLICABILITY

The embodiments of the various seal members as already described may be used to seal a cavity formed by at least three frame members for a myriad of industrial applications including those shown and described with respect to FIGS. 1 thru 6. It is to be understood this is by way of example only and is not limiting in any sense. FIGS. 15 thru 18 illustrate a method for assembling various embodiments of the apparatus of the present disclosure that may be obtained, manufactured, bought or otherwise made available to a user or an assembler. Typically, the apparatus comprises a first seal member that comprises a body defining an aperture with a perimeter and a first sealing feature; and a second seal member that comprises a body with a perimeter that at least partially conforms to the perimeter of the aperture of the first seal member and that includes a sealing portion extending in a direction oblique to its perimeter. These seal members are then used in conjunction with first, second and third frame members to create an apparatus with obliquely sealed joints in a manner as will now be described.

Turning the reader's attention now to FIG. 15, an exploded assembly view of the apparatus shown in FIGS. 3 thru 6 is provided that pictorially represents a method of assembly. As can be seen, an assembler or user inserts (step 1500) the second seal member 314 into a slot 324 positioned in a first frame member 306. In various embodiments, the seal member and the associated seal retaining structure are configured so that the seal is pressed into the slot and held in place thereafter without any effort by the user or assembler to hold the seal, easing assembly. This first frame member is then aligned (step 1502) with a second frame member 204 so that and the two frame members are then fastened together (step 1504). The alignment step may comprise the use of dowel pins or other alignment devices (not shown) so that features found on one frame member properly line up with the features on the corresponding frame member or may be done by eye for more crude applications. Usually, the fastening step 1504 comprises the use of fasteners (e.g. bolts, cap screws, etc.) with bolt holes and threaded holes to allow the repetitive assembly and disassembly of the frame members (see FIG. 1 for fastening step 116). Alternatively, the fastening step may be accomplished using alternative methods such as welding. Once the first and second frame members have been assembled, a first subassembly has been created.

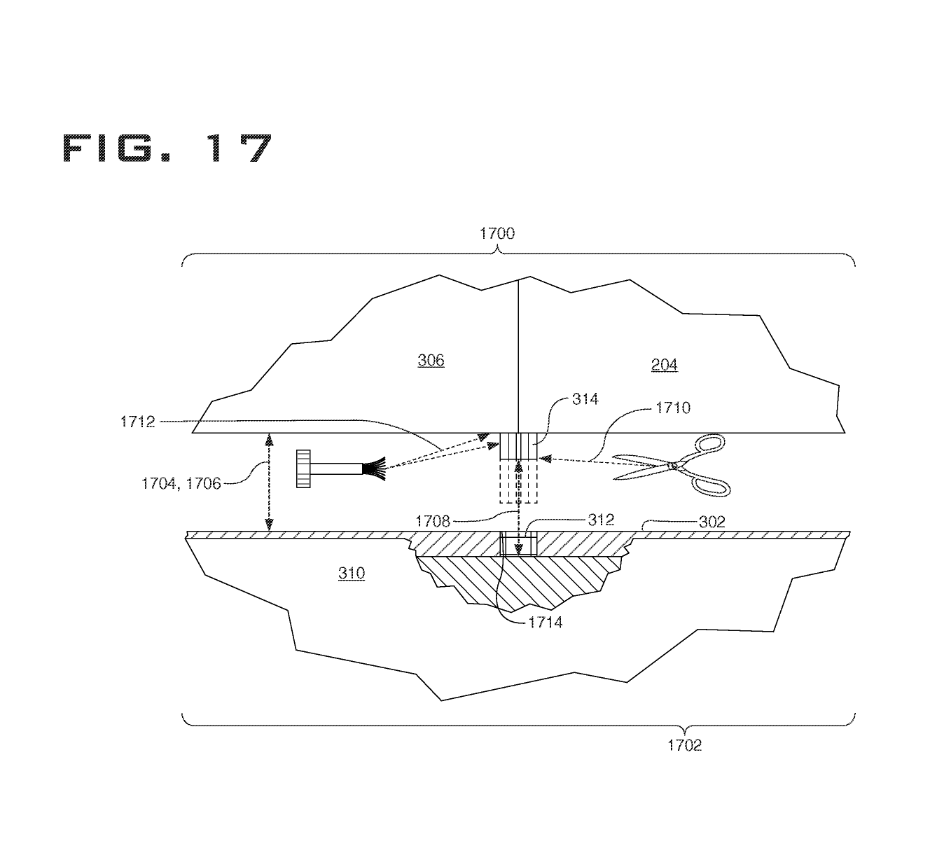

FIG. 16 is an exploded assembly view of the apparatus of FIGS. 3 thru 6 showing the first seal member 302 being inserted (step 1600) into a slot 328 positioned on the third frame member 310. In some embodiments, the first seal member and the associated slot are configured such that the first seal member is a “press-in” seal. The third frame member and the first seal member then constitute a second subassembly. Next, FIG. 17 shows that the first and second subassembly 1700, 1702 are then aligned (step 1704) and brought together by eye or by using alignment devices such as dowel pins (not shown). At about the same time, the second seal member 314 is inserted (step 1708) into the aperture 312 of the first seal member 302 providing seals that extend in oblique directions. In some embodiments, the seals are coincident with each other. The first and second frame members 306, 204 are then fastened (step 1706 or step 112 in FIG. 1) to the third frame member 310 after the free end of the second seal member 314 is received by the aperture 312 or opening of the first seal member 302. Fastening and aligning may be done by the same methods or devices already discussed herein or any other method or device that will provide enough alignment or compression of the first and second seal members to provide fluid tight seals that extend in oblique directions.

Also, a trimming step 1710 may be done before any aligning or fastening steps are performed. Similarly, liquid sealant may be added around the periphery of the portion of the second seal member that extends from the bottom of the frame members that contain it and could also be spread on the bottom surfaces if so desired (see step 1712). Then when the third frame member is connected to the other frame members, the liquid sealant may seal any voids that may exist, helping to prevent any leaks. In other words, the liquid sealant may be used as an aid to create one or more seals as needed or desired.

Also, lead-in or transitional geometry 1714 such as a chamfer, blend, etc. may be provided where the aperture exits the body of the first seal member 302, creating an outer and inner perimeter for the aperture. The outer perimeter would be larger than the perimeter of the second seal member 314 and the transitional geometry would provide guidance as the second seal member finds its way into the aperture during assembly. It is contemplated that liquid sealant may be used to fill in the gap created by this transitional geometry. In addition to or in lieu of the use of liquid sealant, the free end of the second seal member could have stepped geometry that conforms to the transitional geometry to help eliminate any gap found there.

In some embodiments, the first and second frame members are part of a housing and engine block respectively while the third frame member is part of an oil pan. In such a case, the first and second frame members may be top frame members and the third frame member may be a bottom frame member as the oil pan is vertically underneath the housing and engine block. The slot for the first seal member is put into the bottom frame member as it is undesirable to place a slot into the bottom of the engine block as any mistakes machining the slot could result in scrapping the engine block, which is very expensive.

Alternatively, it is contemplated that the first seal member may be held vertically in place by the free end of the second seal member, and preferably, by a plurality of free ends of second seal members that are inserted into a plurality of apertures of the first seal member as may be the case when the first seal forms an enclosed perimeter (such as a u-shaped perimeter about the housing and engine block) about a cavity that requires the sealing of multiple junctions of oblique joints. In such a case, it is useful that the first and second seals be operatively associated such that the second seal member holds onto or retains the first seal member. Then, the first seal may rest underneath the top frame members and be ready for fastening the bottom frame member to the top frame members after the slot of the bottom frame member has been slid onto the first seal member.

In such an embodiment, it may be useful to apply liquid sealant to the free end of the second seal member immediately next to the frame members where it extends from the frame members before inserting the free end into the aperture of the first seal member. Once the first seal member is flush with the surfaces of the frame members, it may harden and hold the first seal member in place until the third frame member can be attached to the other frame members. It may also be useful to use standoffs such as dowel pins or other retention members along the perimeter of the cavity on the underside of the first and second frame members so that multiple apertures provided on the first seal member can be retained by these features as the assembler progresses around the perimeter of the cavity. It is further contemplated that each oblique joint could be created individually and that a tool or fixture could be made available and used to supply enough compression to the joint until the liquid sealant has hardened before attaching the third frame member.

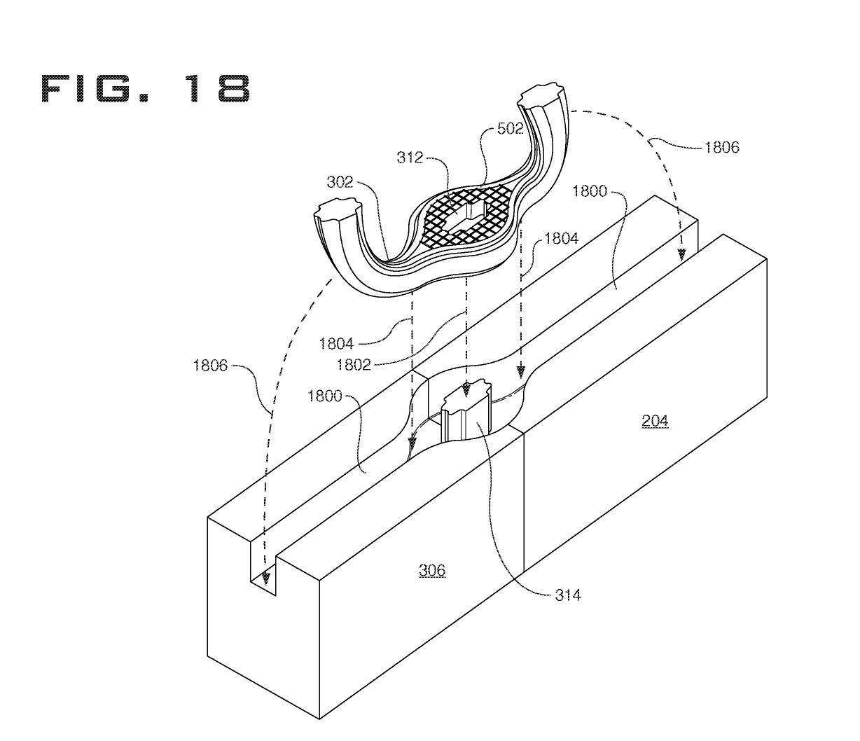

However, it is contemplated that any one of the first, second and third frame members may include a slot into which the first seal member is inserted. For example as shown by FIG. 18, the slot 1800 for the first seal member 302 may be positioned on the bottom surfaces of the top frame members 306, 204 such that the free end of the second seal member 314 is first placed (step 1802) into the aperture 312 of the first seal member 302, the enlarged portion 502 of the first seal member 302 is then pressed into place (step 1804), and then the remainder of the first seal member 302 is inserted (step 1806) into the slot 1800 before the bottom frame member (not shown) is fastened to the top frame members. When threading the free end of the second seal member through the aperture of the first seal member or when inserting the free end of the second seal member into the aperture of the first seal member, the assembler or user should be careful not to provide too much tension or compression to the second seal member as this could cause damage to the seals or otherwise adversely affect the fit of the seals together, hampering the effectiveness of the fluid tight joints.

In any of the embodiments discussed herein where the first and second seal members are held together frictionally such as when the perimeter of the second seal member is larger than the perimeter of the aperture of the first seal member, assembly aids for helping to thread or fish the free end of the second seal member through the aperture of the first seal member may be provided. These aids may include providing tapered ends with chamfers that may be as high on the free end of the second seal member as the thickness of the first seal member. Therefore, no friction or other impedance exists to threading the second seal member into the first seal member until the free end has passed through the aperture, allowing the user or assembler to push until the enlarged portion of the first seal is flush against the top frame members. Or, these aids may include the use of long nose pliers that can extend through the aperture of the first seal member and allow the user or assembler to pull on the free end of the second seal member and push on the first seal member until it rests against the top frame members. Additionally, it is contemplated that custom made tooling or assembly techniques may be supplied to accomplish the assembly of any seal. In some embodiments, the step of inserting the first seal member into a slot positioned on the first, second or third frame member occurs after inserting the second seal member into the aperture of the first seal member.

Putting some of the steps of the assembly method into other words, in some embodiments, either one of the second and third frame members may include a slot or both may include a slot for receiving the second seal member. In such a case, the method of assembly may further comprise the step of inserting the second seal member into a slot positioned on the second or third frame member. In some embodiments, the step of inserting the second seal member into a slot positioned on the second or third frame members occurs before the step of inserting the second seal member into the aperture of the first seal member.

In some embodiments, the method may comprise the step of fastening the first, second, and third frame members together. This step may include the sub-steps of fastening the first and second frame members together followed by another sub-step of fastening the first and third frame members together and yet another sub-step of fastening the second and third frame members together. In some embodiments, the step of fastening the first, second and third frame members together further comprises the sub-step of fastening the first and second frame members together before inserting the first seal member into a slot positioned on the first or second frame member.

In many embodiments, the method of assembly further comprises the step of trimming the length of the second seal member so the cut end of the second seal member is flush to recess as compared to the bottom perimeter of the aperture of the first seal member, that is to say, it does not extend past the body of the first seal member. In many cases, the trimming step occurs after the free end of the second seal member has been threaded through the aperture of the first seal member but can be done beforehand in some embodiments.

It will be apparent to those skilled in the art that various modifications and variations can be made to the embodiments of the apparatus, seal members and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

In particular, it is contemplated that certain embodiments previously discussed herein may include situations where the seal members are assembled together or are unassembled. In some cases, one or the other seal member may be obtained, manufactured, bought or sold separately from the other seal member.

Accordingly, it is intended that the specification and examples be considered as exemplary only, with a true scope and spirit of the invention(s) being indicated by the following claims and their equivalents.

What is claimed is:

1. A first seal member comprising:
a body that defines an aperture that extends along an axis in a first direction from the body, said aperture including a perimeter; and
a first sealing feature that is immediately adjacent at least a portion of the perimeter of the aperture that extends along a plane that is oblique to the first direction along which the aperture extends.

2. The seal member of claim 1 wherein said first sealing feature extends completely along the perimeter of said aperture.

3. The seal member of claim 1 wherein said first direction and said plane are perpendicular to each other.

4. The seal member of claim 1 wherein said aperture forms a completely enclosed perimeter.

5. The seal member of claim 1 wherein said perimeter of said aperture is configured to receive a second seal member that comprises a perimeter wherein the perimeter of the aperture is at least partially complimentarily shaped to the perimeter of the second seal member and at least a portion of the perimeter of the second seal member comprises a sealing portion that extends in a direction that is oblique to the second direction along which the first sealing feature of the first seal member extends.

6. The seal member of claim 1 wherein the first sealing feature comprises a waffle pattern.

7. The seal member of claim 1 wherein said body of the seal member comprises an enlarged portion and at least one narrower portion.

8. The seal member of claim 1 wherein said aperture extends completely through the body of the seal member.

9. The seal member of claim 1 wherein said body comprises at least two planes of symmetry.

10. The seal member of claim 1 wherein said perimeter of the aperture comprises a curved portion and the first sealing feature is positioned to be tangent to this curved portion.

11. A seal assembly comprising:
a first seal member comprising a body that defines an aperture having a perimeter and that extends along an axis in a first direction from the body and that further comprises a first sealing feature that is immediately adjacent at least a portion of the perimeter of the aperture and that extends along a path in a second direction that is oblique to the first direction along which the aperture extends; and
a second seal member comprising a body that includes a perimeter wherein said perimeter of said aperture of the first seal member is at least partially complimentary shaped for receiving the perimeter of the second seal member and wherein said second seal member comprises a sealing portion around its perimeter that extends in a direction that is oblique to its perimeter.

12. The seal assembly of claim 11 wherein said perimeter of the second seal member is at least partially larger than the perimeter of the aperture of the first seal member providing a press-fit when the first and second seal members are assembled.

13. The seal assembly of claim 11 wherein said perimeter of said aperture is completely enclosed.

14. The seal assembly of claim 11 wherein the body of the first seal member includes a sweep path, said body further comprising a first portion including a consistent cross-section found in successive planes perpendicular to the sweep path of the body of the first seal member taken along said sweep path and a second portion including a varying cross-section found in successive planes perpendicular to the sweep path of the body of the first seal member taken along said sweep path that also defines the aperture of the first seal member and wherein the body of the second seal member includes a sweep path, said body of the second seal member also including a consistent cross-section found in successive planes perpendicular to the sweep path of the body of the second seal member taken along said sweep path having a similar shape as the consistent cross-section of the first portion of the first body of the first seal member.

15. The seal assembly of claim 14 wherein said first sealing feature of the first seal member extends in a plane that is oblique to the first direction along which the aperture extends.

16. The seal assembly of claim 11 wherein the first and second seal members both have at least two planes of symmetry.

17. The seal assembly of claim 11 wherein said first and second seal members are assembled together and the first sealing feature of the first seal member is coincident with the sealing portion of the second seal member.

18. An apparatus for providing sealed oblique joints comprising:
a first frame member;
a second frame member that forms a first joint with the first frame member;
a third frame member that forms a second joint with the first or second frame members wherein said joints extend in oblique directions with respect to each other;
a first seal member that is in contact with the first, second and third frame members and that comprises an opening that includes a perimeter; and
a second seal member that is in contact with the said first and second frame members and is in contact with at least a portion of the perimeter of the opening of the first seal member.

19. The apparatus of claim 18 wherein said second seal member is operatively associated with the first seal member for retaining the first seal member.

20. The apparatus claim 19 wherein said opening of said first seal member is a hole with an enclosed perimeter that is configured to frictionally receive the second seal member.
